(19) United States
(12) Patent Application Publication
(10) Pub. No.: US 2006/0271935 A1
(43) Pub. Date: Nov. 30, 2006

(54) Assignment of clients to tasks in a distributed system

(75) Inventors: Shaun D. Cox, Redmond, WA (US); Thane Peterson, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/142,907

(22) Filed: May 31, 2005

(51) Int. Cl. G06F 9/46

(52) U.S. Cl. 718/102

(57) ABSTRACT

An assignment system includes a client component and a server component. The client component, which executes on each client, requests the server component, which executes on the server, to perform the task on its behalf. When the server component is requested to perform the task on behalf of a client, it determines whether an available client is currently assigned to that task. If an available client is not currently assigned to the task, the server component assigns an available client to the task. If the client on whose behalf the server component is executing is assigned to the task, then the server component performs the task. Otherwise, the server component does not perform the task.

### BACKGROUND

Presence servers are increasingly being used to provide presence information such as the availability status of users. Presence information identifies the current “presence state” of the user. Users make their presence information available so that other users can decide how best to communicate with them. For example, the presence information may indicate whether a user is logged on (“online”) with an instant messaging server or is logged off (“offline”). Presence information may also provide more detailed information about the availability of the user. For example, even though a user is online, that user may be away from their computer in a meeting. In such a case, the presence state may indicate “online” and “in a meeting.”

In an instant messaging context, a publishing user (“publisher”) may provide their presence information to a presence service that then provides the presence information to subscribing users (“subscribers”). Thus, a presence service may use a subscriber/publisher model to provide the presence information for the users of the presence service. Whenever the presence information of a user changes, the presence service is notified of the change by that user's computer system and in turn notifies the subscribing users of the change. A subscribing user can then decide whether to initiate an instant messaging conversation based on the presence information of the intended participants. For example, if the presence information indicates that a publishing user is currently in a conference telephone call, then the subscribing user may decide to send an instant message, rather than place a telephone call, to the publishing user. If the subscribing user, however, needs to call and speak with the publishing user, the subscribing user needs to monitor the presence information of the publishing user to know when the call can be placed. When the subscribing user notices that the publishing user's presence information indicates that the telephone conference has been concluded, the subscribing user can then place the telephone call.

Because of the increasing popularity of instant messaging systems and other real-time communication systems, presence services need to support an increasing numbers of users. To support large numbers of users, a presence service may provide a pool of front-end presence servers that are used to service the publication and subscription requests of users. Subscription and publication requests are typically routed through a load balancer of the presence service which directs the request to one of the presence servers based on the current load of the presence servers. The information of the presence service may be stored and accessed through a back-end database server, which may be a SQL server. The back-end database server may store the current presence information of each publisher, and for each publisher, store the identity of each subscriber to that publisher's presence information in database tables. When a front-end presence server receives a request, it accesses the back-end database server to respond to the request.

Various maintenance tasks need to be performed from time to time on the tables of a back-end database. For example, a subscription to the presence information of a user may expire after a certain period (e.g., eight hours). To continue subscribing to another user's presence information, a user would need to periodically re-subscribe to that other user's presence information. To ensure that tables of the database do not become filled with expired subscriptions, a maintenance task needs to be performed periodically to remove information related to expired subscriptions. More generally, in many computing environments client computer systems (e.g., front-end servers) access server computer systems (e.g., back-end database servers) that need to have maintenance tasks performed from time to time. As another example, a Session Initiation Protocol (“SIP”) registry may have a database server that maintains the registration information of registered users. Because such registrations expire, a maintenance task of removing information relating to expired registrations needs to be performed from time to time. As another example, the maintenance task may be to re-index certain tables of the database. In addition, non-maintenance tasks may need to be performed such as generating certain reports on a periodic basis, forwarding certain information to another server, uploading summary information to another computer system, and so on.

It is typically difficult to customize the back-end database server so that it can perform such maintenance tasks on its own initiative. As a result, a front-end server may be designated to perform various tasks on the database. However, when a front-end server is taken down for maintenance or fails, the tasks that the front-end server was responsible for performing will no longer be performed.

### SUMMARY

A method and system for assigning clients to tasks is provided. The assignment system includes a client component and a server component. The client component, which executes on each client, requests the server component, which executes on the server, to perform the task on its behalf. When the server component is requested to perform the task on behalf of a client, it determines whether an available client is currently assigned to that task. If an available client is not currently assigned to the task, the server component assigns an available client to the task. If the client on whose behalf the server component is executing is assigned to the task, then the server component performs the task. Otherwise, the server component does not perform the task. Because each client periodically requests the server component to perform the task, the server component will perform the task when requested by the assigned client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates the interconnections between user devices and a server pool in one embodiment.

FIG. 2 is a block diagram that illustrates components of the server component of the assignment system in one embodiment.

FIG. 3 is a block diagram that illustrates data structures of the server component in one embodiment.

FIG. 4 is a block diagram that illustrates components of the client component of the assignment system in one embodiment.

FIG. 5 is a flow diagram that illustrates the processing of the stored procedure for a task in one embodiment.

FIG. 6 is a flow diagram that illustrates the processing of the retrieve client assigned to task component of the server component in one embodiment.

FIG. 7 is a flow diagram that illustrates the processing of the select client for task component of the server component in one embodiment.

### DETAILED DESCRIPTION

A method and system for assigning clients to tasks is provided. In one embodiment, the assignment system includes a client component and a server component. The client component, which executes on each client, requests the server component, which executes on the server, to perform the task on its behalf. When the server component is requested to perform the task on behalf of a client, it determines whether an available client is currently assigned to that task. A client is available if it can request the server component to perform the task on its behalf. As an example, a client that is offline for maintenance or that has malfunctioned is not available. If an available client is not currently assigned to the task, the server component assigns an available client to the task. If the client on whose behalf the server component is executing is assigned the task, then the server component performs the task. Otherwise, the server component does not perform the task. Because each client periodically requests the server component to perform the task, the server component will perform the task when requested by the assigned client. If the assigned client becomes unavailable, the server component will assign a new available client to the task. In this way, the server component will perform the task only on behalf of the assigned client, and when the assigned client becomes unavailable, the server component will dynamically assign an available client to perform the task.

In one embodiment, the server is a database server, and the server component is a stored procedure that is invoked by the clients. The server component may include a stored procedure for each task that is to be performed at the server on behalf of a client. For example, a presence service may have a stored procedure for removing expired subscriptions, another stored procedure for removing expired registrations, and another stored procedure for re-indexing certain tables. Each client may periodically invoke each of the stored procedures to perform the tasks on its behalf. Each stored procedure may include a retrieval component for retrieving the identity of the client assigned to the task and a task component for performing the task when the client on whose behalf the stored procedure is invoked is the assigned client. When the server component is invoked, it invokes the retrieval component to determine whether an available client is currently assigned to the task. If not, the retrieval component selects an available client to assign to the task. The retrieval component may select the client that currently is assigned to the smallest number of tasks. Alternatively, the retrieval component may select a client factoring in the complexities and number of tasks to which it is assigned. Upon receiving an indication of the assigned client, the server component determines whether it is being performed on behalf of the assigned client. If so, the server component invokes the task component to perform the task. If not, the server component completes without performing the task.

In one embodiment, the server component uses a locking mechanism (e.g., a mutual exclusion mechanism) to prevent multiple invocations of a stored procedure from simultaneously accessing information needed to assign a client to a task. The server component may maintain client information indicating whether the client is available and, if so, to which tasks it is assigned. Because the clients may not coordinate the timing of their invocation of the stored procedures, it is possible that multiple clients may invoke the same stored procedure at nearly the same time. If multiple invocations of a stored procedure attempt to assign a client to the task at approximately the same time, the client information may be left in an inconsistent state. To prevent the simultaneous access of the client information by the invocations of a stored procedure, the stored procedure locks a database resource exclusively before accessing the client information and unlocks the database resource after access is complete. For example, the server component may maintain a task table that includes a row for each task which identifies the client currently assigned to the task. When the stored procedure for a task is invoked, that stored procedure attempts to exclusively lock the row for that task. If the row is currently locked, the invocation of the stored procedure will wait until the row is unlocked. If the row is currently unlocked, then the stored procedure will lock the row and continue processing. Thus, the locking of the row of a task will serialize the assigning of a client to the task by the invocations of the stored procedure for that task. The stored procedure removes the lock after the assigned client has been identified and before invoking the task component to perform the task. In this way, the client will only need to wait for a lock that spans only the assignment of a client to a task and need not wait for a lock that spans the performance of the task itself, which may take a considerable amount of time.

In one embodiment, the task assignment system uses a heartbeat mechanism to determine whether a client is available. The client component of a client may periodically send a heartbeat notification to the server. Upon receiving the heartbeat notification, the server component may record the time of the heartbeat. The server component may assume that a client is available when the last heartbeat from that client was received within a certain period. For example, the server component may assume that a client is available when the last heartbeat from that client was received within two minutes. The client component may provide the heartbeat notification to the server by periodically invoking a heartbeat stored procedure of the server. The server component may maintain a client table with a row for each client, which identifies the time that the last heartbeat notification was received from that client. When the heartbeat stored procedure is invoked on behalf of a client, it updates the last heartbeat notification time for that client in the client table. The stored procedure of the task uses the last heartbeat notification time to determine whether a client is available.

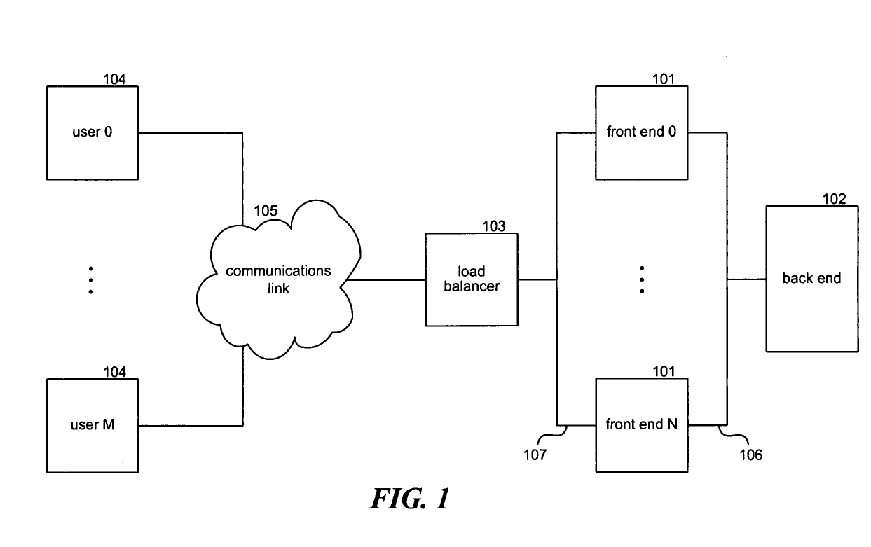

FIG. 1 is a block diagram that illustrates the interconnections between user devices and a server pool in one embodiment. The server pool includes front-end servers 101 that are connected to a back-end server 102 via communications link 106, such as a local area network. The back-end server may be a database server for a relational database (e.g., SQL) that stores data of a presence service. The front-end computers are connected via communications link 107, such as local area network, to load balancer 103. The load balancer is connected to user devices 104 via communications link 105, such as the Internet. The user devices send registration requests, publication requests, and subscription requests to the load balancer. Requests may be sent using the Session Initiation Protocol. Upon receiving a request, the load balancer identifies a front-end server that has the capacity to service the request and forwards the request to the identified front-end server. The front-end server services the request by accessing the data maintained by the back-end server. Each front-end server includes a client component of the assignment system, and the back-end server includes the server component of the assignment system. The server component includes a stored procedure for each task and a stored procedure for heartbeat notification. The client component of each front-end server periodically invokes the heartbeat stored procedure and each task stored procedure of the back-end server.

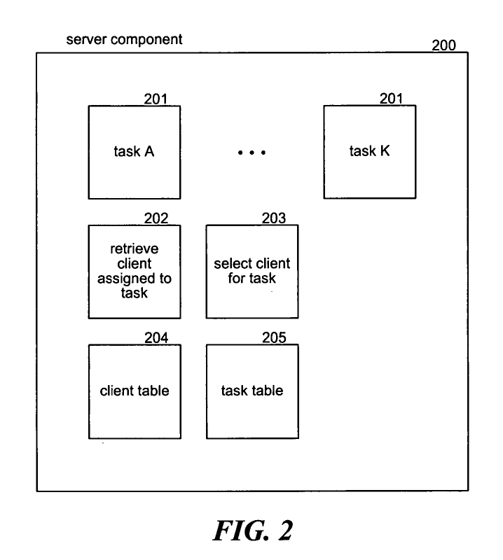

FIG. 2 is a block diagram that illustrates components of the server component of the assignment system in one embodiment. The server component 200 includes stored procedures 201 for each task that needs to be performed at the server. The server component also includes a retrieve client assigned to task component 202 and a select client for task component 203. The retrieve client assigned to task component is invoked by each task stored procedure to retrieve the identity of the client that is currently assigned to the task of that stored procedure. The retrieve client assigned to task component invokes the select client for task component when a client needs to be assigned to the task. The select client for task component identifies an available client and assigns that client to the task. The server component includes a client table 204 and a task table 205. The client table contains an entry for each client that is registered with the server. For example, when a client initially comes online, it may notify the server and the server may add a row to the client table for that client. The client table may include a column for storing the time of the last heartbeat notification. The task table includes a row for each task and a column that identifies the client that is currently assigned to that task.

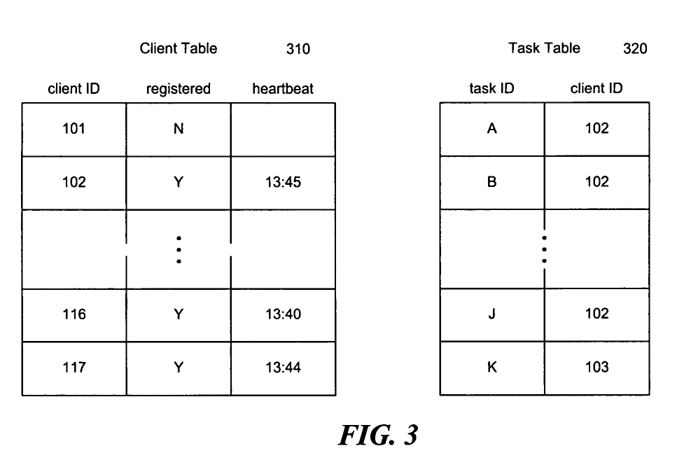

FIG. 3 is a block diagram that illustrates data structures of the server component in one embodiment. The server component includes a client table 310 and a task table 320. The client table includes a row for each client and a client identifier column, a registered column, and a heartbeat column. The client identifier column stores the identifier of a client, the registered column stores a flag indicating whether the client has registered, and the heartbeat column stores the time at which the last heartbeat notification was received from the client. For example, the row for the client with client identifier 102 indicates that the client is registered and that the last heartbeat notification was received at 13:45. The task table includes a row for each task and a task identifier column and a client identifier column. The task identifier column stores the identifier of the task, and the client identifier column stores the identifier of the client currently assigned to the task. For example, client 102 is currently assigned to tasks A, B, and J, and client 103 is currently assigned to task K.

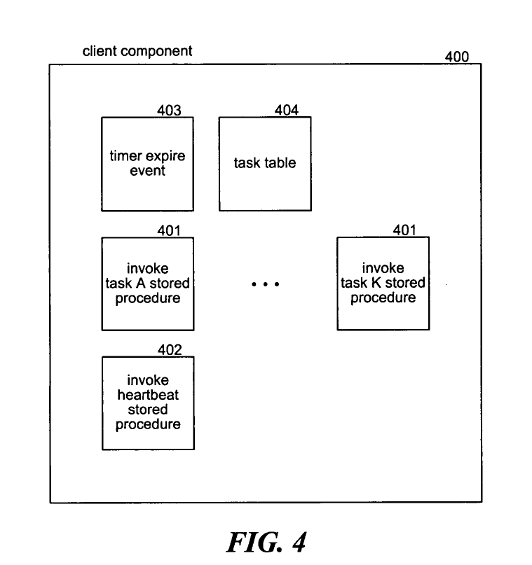

FIG. 4 is a block diagram that illustrates components of the client component of the assignment system in one embodiment. The client component 400 includes an invoke task stored procedure component 401 for each task that needs to be performed on the server. Each invoke task stored procedure component invokes the corresponding task stored procedure on the server. The client component also includes an invoke heartbeat stored procedure component 402 that invokes the heartbeat stored procedure of the server. The client component includes a timer expired event component 403 that is invoked periodically (e.g., every two minutes) as a timer expires. The timer expired event component invokes the invoke heartbeat stored procedure component and may invoke one of the invoke task stored procedure components. The task table 404 may contain information describing when each task should be performed on behalf of the client. For example, the client component may invoke the stored procedure for one task each time it is invoked in a round-robin manner. Alternatively, the task table may identify the various times of day when the stored procedure for each task should be invoked.

The computing device on which the assignment system is implemented may include a central processing unit, memory, input devices (e.g., keyboard and pointing devices), output devices (e.g., display devices), and storage devices (e.g., disk drives). The memory and storage devices are computer-readable media that may contain instructions that implement the assignment system. In addition, the data structures and message structures may be stored or transmitted via a data transmission medium, such as a signal on a communications link. Various communication links may be used, such as the Internet, a local area network, a wide area network, a point-to-point dial-up connection, a cell phone network, and so on.

Embodiments of the assignment system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The user devices may be cell phones, personal digital assistants, smart phones, personal computers, programmable consumer electronics, digital cameras, and so on.

The assignment system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

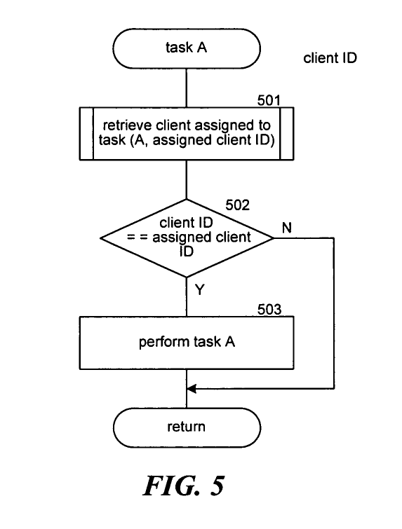

FIG. 5 is a flow diagram that illustrates the processing of the stored procedure for a task in one embodiment. The stored procedure is passed the client identifier of the client on whose behalf the stored procedure is being invoked. In block 501, the stored procedure invokes the retrieve client assigned to task component passing an indication of the task to be performed and receiving an indication of the client assigned to perform that task. In decision block 502, if the client on whose behalf the stored procedure was invoked is the assigned client, then the stored procedure continues at block 503, else the stored procedure completes. In block 503, the stored procedure performs the task and then completes.

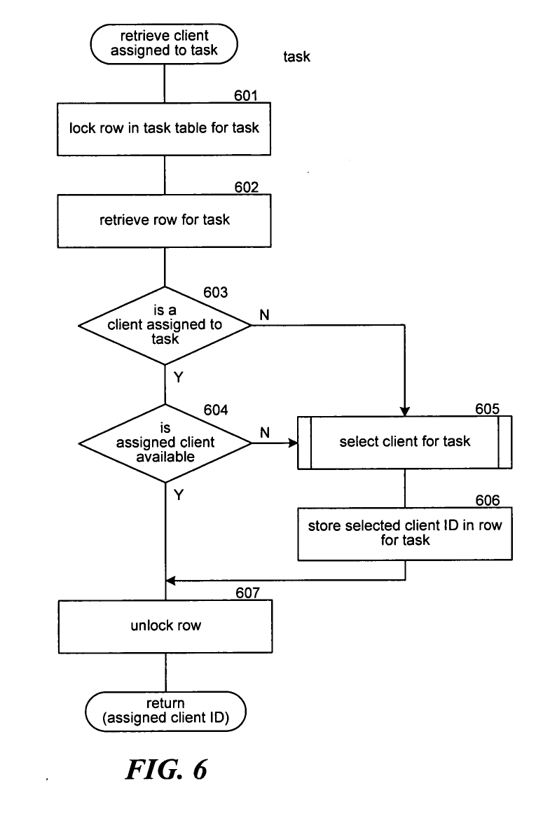

FIG. 6 is a flow diagram that illustrates the processing of the retrieve client assigned to task component of the server component in one embodiment. The component is passed an indication of the task to be performed and returns an indication of the client assigned to perform that task. In block 601, the component locks the row in the task table for the passed task. If the row is already locked, the component waits until it is unlocked before locking it. In block 602, the component retrieves the row for the passed task from the task table. In decision block 603, if a client is currently assigned to the task, then the component continues at block 604, else the component continues at block 605. In decision block 604, if the assigned client is currently available, then the component continues at block 607, else the component continues at block 605. In block 605, the component invokes the select client for task component to select a client to assign to the task. In block 606, the component assigns the selected client to the task by storing the client identifier of the selected client in the row for the passed task. In block 607, the component unlocks the row in the task table for the passed task and then returns an indication of the assigned client.

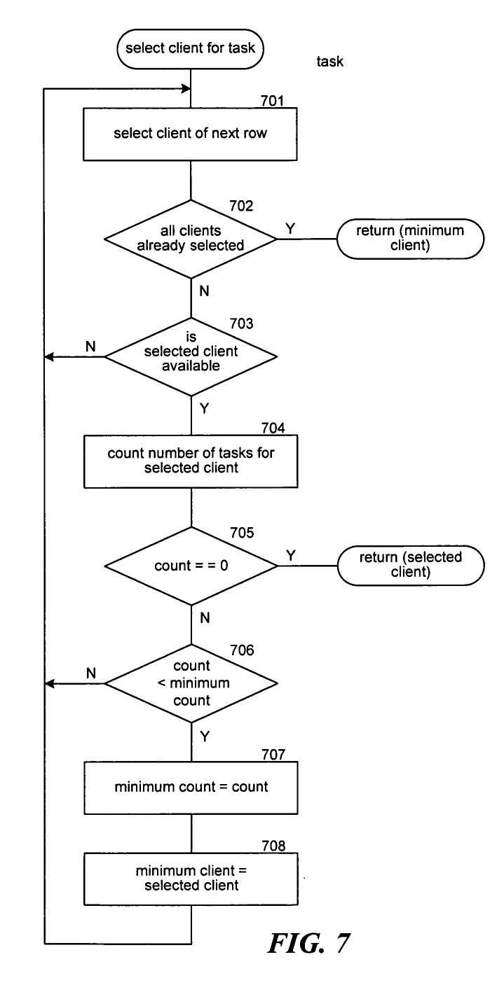

FIG. 7 is a flow diagram that illustrates the processing of the select client for task component of the server component in one embodiment. The component is invoked when an available client is not currently assigned to a task. The component is passed an indication of the task. In this embodiment, the component selects the client that has the minimum number of tasks assigned to it. In blocks 701-708, the component loops selecting each client and determining whether the selected client should be assigned to the passed task. In block 701, the component selects the client of the next row of the client table. In decision block 702, if all the rows of the client table have already been selected, then the component returns an indication of the client that has the minimum number of tasks assigned to it, else the component continues at block 703. In decision block 703, if the selected client is available, then the component continues at block 704, else the component loops to block 701 to select the next client. In block 704, the component counts the number of tasks to which the selected client is assigned by accessing the task table. In decision block 705, if the count is zero, then the selected client has the minimum number of tasks assigned to it, and the component returns an indication of the selected client, else the component continues at block 706. In decision block 706, if the count for the selected client is less than the minimum count encountered so far, then the component continues at block 707, else the component loops to block 701 to select the next client. In block 707, the component sets the minimum count encountered so far to the count of the selected client. In block 708, the component sets the minimum client identifier to the identifier of the selected client and then loops to block 701 to select the next client.

From the foregoing, it will be appreciated that specific embodiments of the assignment system have been described herein for purposes of illustration, but that various modifications may be made without deviating from the spirit and scope of the invention. One skilled in the art will appreciate that a client is a computer system that accesses services of a server. A client may itself be a server to other clients. For example, a front-end presence server may be a client of a back-end database server and may be a server to user devices, which are clients of the front-end presence server. Accordingly, the invention is not limited except as by the appended claims.

I/We claim:

1. A method in a computer system for performing a task, the method comprising:
receiving from a requesting client a request to perform the task;
determining whether the task is assigned to an available client;
when it is determined that the task is not assigned to an available client, assigning the task to an available client; and
when the requesting client is the client that is assigned to the task, performing the task on behalf of the requesting client.

2. The method of claim 1 including maintaining a task table with an entry for each task that indicates the client assigned to that task and locking the entry after receiving the request to prevent the assigning of a client to be simultaneously performed on behalf of multiple clients.

3. The method of claim 2 including unlocking the entry before performing the task.

4. The method of claim 2 wherein the computer system provides a relational database and the task table is a table of the relational database.

5. The method of claim 4 wherein the determining and assigning are performed by a stored procedure of the relational database.

6. The method of claim 1 wherein a client provides heartbeats to the computer system and a client is available when a heartbeat has recently been provided by that client.

7. The method of claim 1 including maintaining a client table with an entry for each client indicating the availability of that client.

8. The method of claim 1 wherein the computer system is a database server that provides presence information for a presence service.

9. The method of claim 1 wherein the task is selected from the group consisting of cleaning up expired subscriptions to presence information, cleaning up expired registration records, re-indexing database tables, and replicating information from a data source.

10. The method of claim 1 including receiving on a periodic basis requests to perform the task from each client.

11. The method of claim 1 wherein the client assigned to the task is the client that is currently assigned to the smallest number of tasks.

12. A computer-readable medium containing a stored procedure for controlling a database server to perform a task when the stored procedure is invoked by clients, by a method comprising:
locking a resource of the database server;
when the resource is locked, identifying a client assigned to perform the task;
unlocking the resource after a client is identified; and
after the resource is unlocked, when the client that invoked the stored procedure is the client identified as being assigned to perform the task, performing the task.

13. The computer-readable medium of claim 12 wherein the database includes a table with an entry for each task and wherein the resource is the entry corresponding to the task.

14. The computer-readable medium of claim 12 containing a heartbeat stored procedure that clients invoke to indicate their availability to the database server.

15. The computer-readable medium of claim 12 wherein the identifying of a client includes identifying an available client that is currently assigned to the task.

16. The computer-readable medium of claim 12 wherein the identifying of a client includes identifying an available client when no available client is currently assigned to the task.

17. A computer-readable medium containing instructions for controlling a client to cause a task to be performed on a server, by a method comprising:
invoking a heartbeat stored procedure of the server to notify the server that the client is available; and
invoking a task stored procedure of the server, the task stored procedure for performing the task when the invoking client is assigned to the task and for not performing the task when the invoking client is not assigned to the task.

18. The computer-readable medium of claim 17 wherein the client periodically invokes the heartbeat stored procedure and the task stored procedure.

19. The computer-readable medium of claim 17 wherein the task is to remove expired subscriptions of a publication system.

20. The computer-readable medium of claim 17 wherein the server locks a database resource to prevent different invocations of the task stored procedure from simultaneously assigning a client to the task.
